(19) United States
(12) Patent Application Publication
(10) Pub. No.: US 2020/0034827 A1
(43) Pub. Date: Jan. 30, 2020

(54) JUSTWALLET PAYMENT SYSTEMS AND METHOD

(71) Applicant: Hamilton Cheong, Thornhill (CA)

(72) Inventor: Hamilton Cheong, Thornhill (CA)

(21) Appl. No.: 16/205,136

(22) Filed: Nov. 29, 2018

(30) Foreign Application Priority Data
Jul. 26, 2018 (CA) 3012504

(51) Int. Cl. G06Q 20/36; G06Q 20/40; G06Q 20/38; G06Q 20/20

(52) U.S. Cl. CPC G06Q 20/36; G06Q 20/202; G06Q 20/387; G06Q 20/40

(57) ABSTRACT

A method and system for processing any form of payment transaction associated with a purchase made at any business. The method and system involves an authorization algorithm of code that of the issuer payment system of a JUSTWALLET payment being received, receiving a payment authorization request message associated with the purchase from a payment network server, and generating an authorization response message indicative of an outcome of the payment authorization request for communication to the merchant's terminal.

### BACKGROUND OF THE INVENTION

This application claims benefit under 35 USC 119 to Canada National Application Serial No. 3,012,504 filed Jul. 26, 2018 the disclosure of which is incorporated herein by reference in its entirety. The following includes information that may be useful in understanding the present disclosure. It is not an admission that any of the information provided herein is prior art nor material to the presently described or claimed inventions, nor that any publication or document that is specifically or implicitly referenced is prior art.

### TECHNICAL FIELD

The present invention relates generally to the field of data processing: financial, business practice, management, or cost/price determination of existing art and more specifically relates to data processing: financial, business practice, management, or cost/price determination including funds transfer or credit transaction.

### RELATED ART

Many individuals in modern society purchase goods and services for consumption. These goods or services typically cost money. Traditionally, many goods or services purchased were paid for with cash or check. Modernly many individuals also pay with credit cards or via electronic payment means. These purchases can be made in brick and mortar establishments and alternately can be made online. Further, businesses may offer ‘rewards’ points and the like to entice buyers to shop with them more often and to reward the purchaser for loyalty of his/her purchases. It is desirable to track these financial transactions to discourage fraud stemming from unauthorized purchases. It is also desirable to couple the financial transaction with any rewards program, coupons or the like that may be offered. Thus, a suitable solution is desired.

U.S. Pub. No. 2007/0150411 to Sateesh Addepalli, Sumit Gautam, and Atul Shinde relates to a universal payment system. The described universal payment system relates to a universal payment, coupon redemption and customer loyalty system. Consumers may purchase goods and services through a universal payment identifier that facilities Internet, merchant, and consumer-to-consumer or mobile-to-mobile transfer of money and non-cash instruments. The universal payment identifier may be used as a universal credit/debit card, coupon redemption card, means of tracking consumer behavior, or means to dynamically associate different payment accounts.

### SUMMARY OF THE INVENTION

In view of the foregoing disadvantages inherent in the known data processing: financial, business practice, management, or cost/price determination including funds transfer or credit transaction art, the present disclosure provides a novel JUSTWALLET payment system. The general purpose of the present disclosure, which will be described subsequently in greater detail, is to provide an efficient and effective method and system for processing any form of payment transaction associated with a purchase made at or from any business or with an ATM/ABM transaction.

A first method of use for a justwallet payment system is disclosed herein for processing payment transactions comprising the steps of: providing an authorization algorithm of code which is that of an issuer payment system; receiving a JUSTWALLET payment; receiving a payment authorization request message associated with a purchase from a payment network server, and generating an authorization response message indicative of an outcome of an associated payment authorization request for communication to a corresponding merchant's terminal; wherein an issuer system has a response-generation IPN configured to identify supplementary data. The supplementary data has been pre-registered by a justwallet holder. The supplementary data has been pre-registered by the justwallet holder at an issuer system; wherein the supplementary data in the authorization response message is configured such that the merchant's terminal is able to extract the supplementary data (extracted supplemental data). The merchant's terminal is able to extract payment for purchase and to initiate another transaction from the merchant's terminal. The extracted supplementary data is a loyalty transaction related to the purchase and alternately another-purchase and alternately a transfer.

A second method of use for a justwallet payment system is also disclosed herein for processing payment transactions comprising the steps of: providing an authorization algorithm of code which is that of an issuer payment system; receiving a JUSTWALLET payment; receiving a payment authorization request message associated with a purchase from a payment network server, and generating an authorization response message indicative of an outcome of an associated payment authorization request for communication to a corresponding merchant's terminal; wherein an issuer system has a response-generation IPN configured to identify supplementary data. The supplementary data has been pre-registered by a justwallet holder. The supplementary data has been pre-registered by the justwallet holder at an issuer system; wherein the supplementary data in the authorization response message is configured such that a wallet is able to extract the supplementary data. The wallet is able to extract payment for a purchase and to initiate another transaction from the wallet; wherein the supplementary extracted data is a digital-wallet payment transaction. The digital-wallet payment transaction is related to the purchase, to a previous-purchase, and alternately to a transfer.

For purposes of summarizing the invention, certain aspects, advantages, and novel features of the invention have been described herein. It is to be understood that not necessarily all such advantages may be achieved in accordance with any one particular embodiment of the invention. Thus, the invention may be embodied or carried out in a manner that achieves or optimizes one advantage or group of advantages as taught herein without necessarily achieving other advantages as may be taught or suggested herein. The features of the invention which are believed to be novel are particularly pointed out and distinctly claimed in the concluding portion of the specification. These and other features, aspects, and advantages of the present invention will become better understood with reference to the following drawings and detailed description.

### BRIEF DESCRIPTION OF THE DRAWINGS

The figures which accompany the written portion of this specification illustrate embodiments and methods of use for the present disclosure, a JUSTWALLET payment system, constructed and operative according to the teachings of the present disclosure.

FIG. 1 is a perspective view of the justwallet payment system during an ‘in-use’ condition, according to an embodiment of the disclosure.

FIG. 2 is a flowchart of a first embodiment of the justwallet payment system of FIG. 1, according to an embodiment of the present disclosure.

FIG. 3 is another flowchart of a first embodiment of the justwallet payment system of FIG. 1, according to an embodiment of the present disclosure.

FIG. 4 is a flowchart of a second embodiment of the justwallet payment system of FIG. 1, according to an embodiment of the present disclosure.

FIG. 5 is another flowchart of a second embodiment of the justwallet payment system of FIG. 1, according to an embodiment of the present disclosure.

The various embodiments of the present invention will hereinafter be described in conjunction with the appended drawings, wherein like designations denote like elements.

### DETAILED DESCRIPTION

As discussed above, embodiments of the present disclosure relate to a data processing: financial, business practice, management, or cost/price determination including funds transfer or credit transaction and more particularly to a justwallet payment system as used to improve processing of payment transactions.

Generally, the present invention is a method and system for processing any form of payment transaction associated with a purchase made at any business or ATM/ABM or other terminal. The proposed disclosure involves an authorization algorithm of code that of the issuer payment system of a JUSTWALLET payment being received, receiving a payment authorization request message associated with the purchase from a payment network server, and generating an authorization response message indicative of an outcome of the payment authorization request for communication to the merchant's terminal. The issuer system has a response-generation IPN configured to identify supplementary data which has been pre-registered by the associated Wallet holder at the issuer system, and to include the supplementary data in the authorization response message so that the merchant's terminal or wallet may extract the supplementary data, and payment and may use the extracted data to initiate another transaction, such as a loyalty transaction or digital-wallet payment transaction, which is related to the purchase or other purchases or transfer.

The present invention is: 1) Wallet-to-wallet exchange 2) Aggregator, processor, transactor, all in one 3) Funds go to just wallet from user 4) Use existing rails depending on source/recipient account 5) Currency exchange and wallet exchange 6) Fee paid by either sender or receiver 7) Image/screenshot base initiation of the transaction (hooked into payment system 8) Go directly to transaction/payment page from image/photo/screenshot 9) Plug-in based system, hooks into existing software/platform 10) Only one party needs a wallet account 11) User purchases, select payment type, transaction goes to wallet (justwallet), and then wallet settles with vendor—user doesn't notice 12) If user has wallet, can directly scan products (skip cashier) 13) QR code scanning of flyers

The present invention features: Internal Currency Exchange; Screenshot/Image Payment; Instant payment Notification “IPN”; Internal KYC/AML/BSA: Verification System and bridging all payment methods and currencies into 1 platform.

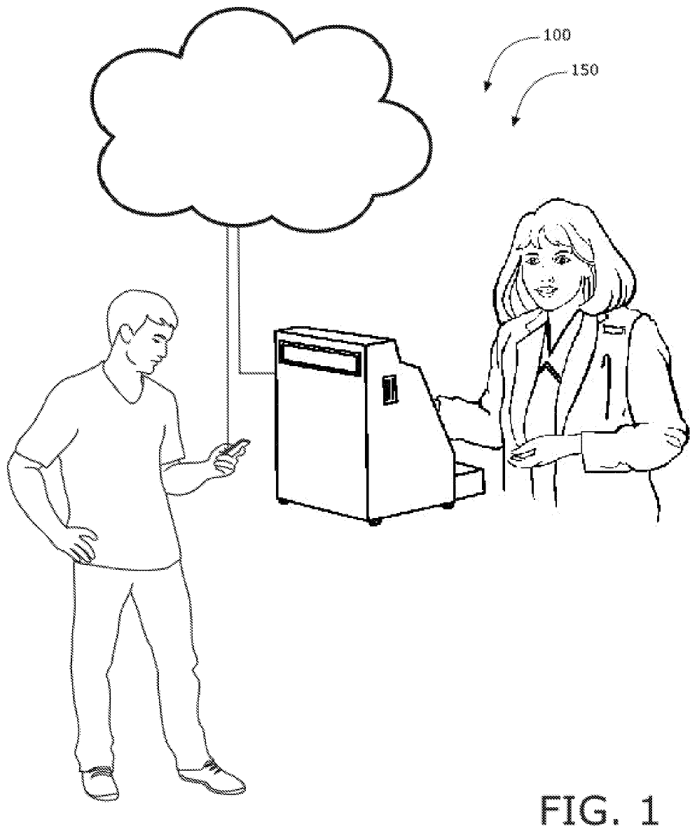

Referring now more specifically to the drawings by numerals of reference, there is shown in FIGS. 1-5, various views, flowcharts and disclosure related to a justwallet payment system 100.

FIG. 1 shows a justwallet payment system 100 during an ‘in-use’ condition 150, according to embodiments of the present disclosure. Here, the justwallet payment system 100 may be beneficial for use by a user to efficiently process payment transactions. As illustrated, the justwallet payment system 100 may include a first method 500 and a second method 600 of use for a justwallet payment system 100 for processing payment transactions.

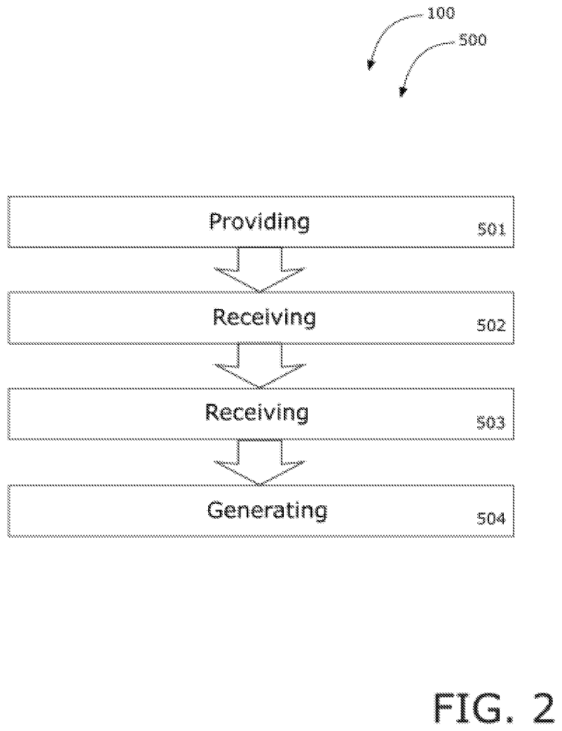

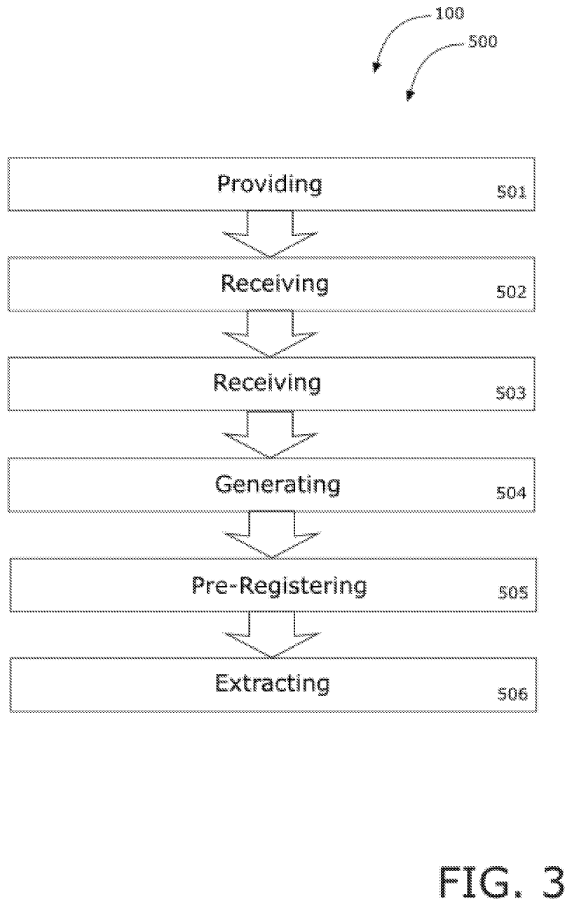

FIGS. 2-3 speak to a first method of use 500 for a justwallet payment system 100 is disclosed herein for processing payment transactions comprises the steps of step one 501: providing an authorization algorithm of code which is that of an issuer payment system; step two 502 receiving a JUSTWALLET payment; step three 503 receiving a payment authorization request message associated with a purchase from a payment network server, and step four 504 generating an authorization response message indicative of an outcome of an associated payment authorization request for communication to a corresponding merchant's terminal; wherein an issuer system has a response-generation IPN configured to identify supplementary data. In this context, the merchant's terminal may be a physical terminal, a digital/virtual terminal, an ATM or ABM, or another's party's device (phone, tablet, etc.). The supplementary data has been pre-registered by a justwallet holder (step five 505). The supplementary data has been pre-registered by the justwallet holder at an issuer system; wherein the supplementary data in the authorization response message is configured such that the merchant's terminal is able to extract the supplementary data (extracted supplemental data). The merchant's terminal is able to extract payment for purchase and to initiate another transaction from the merchant's terminal as a step six 506. The extracted supplementary data is a loyalty transaction related to the purchase and alternately another-purchase and alternately a transfer. Those with ordinary skill in the art will now appreciate that upon reading this specification and by their understanding the art of digital wallet use as described herein, methods of transacting will be understood by those knowledgeable in such art.

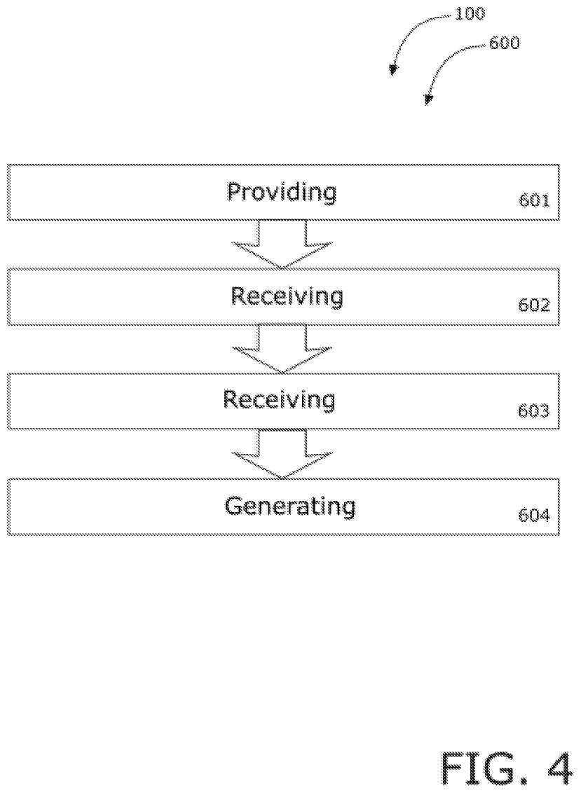

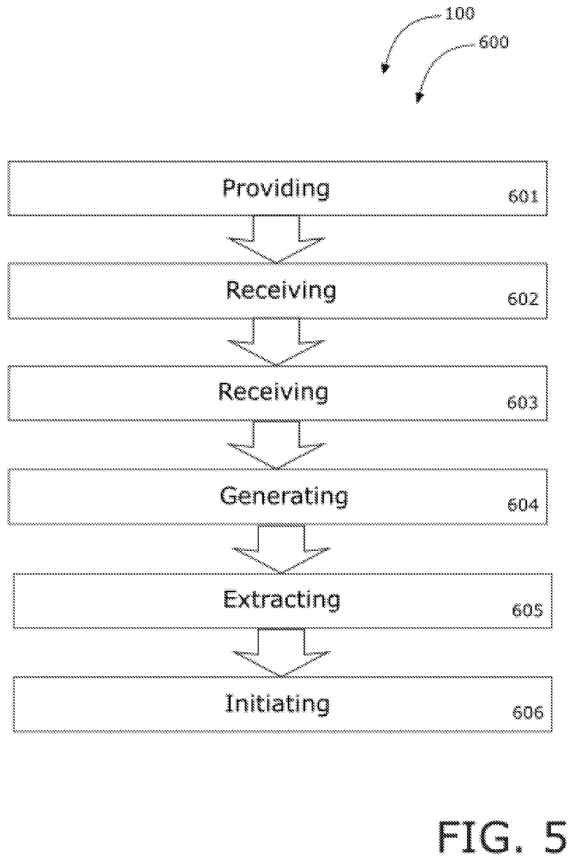

Referring now to FIGS. 4-5 showing flowcharts of the justwallet payment system 100 of FIG. 1, according to an embodiment of the present disclosure. FIGS. 4-5 speak to a second method of use 600 for a justwallet payment system 100 for processing payment transactions comprising the steps of: step one 600 providing an authorization algorithm of code which is that of an issuer payment system; step two 602 receiving a JUSTWALLET payment; step three 603 receiving a payment authorization request message associated with a purchase from a payment network server, and step four 604 generating an authorization response message indicative of an outcome of an associated payment authorization request for communication to a corresponding merchant's terminal; wherein an issuer system has a response-generation IPN configured to identify supplementary data. Again, in this context, the merchant's terminal may be a physical terminal, a digital/virtual terminal, an ATM or ABM, or another's party's device (phone, tablet, etc.). The supplementary data has been pre-registered by a justwallet holder. The supplementary data has been pre-registered by the justwallet holder at an issuer system; wherein the supplementary data in the authorization response message is configured such that a wallet is able to extract the supplementary data. The wallet is able to extract payment step five 605 for a purchase and step six 606 to initiate another transaction from the wallet; wherein the supplementary extracted data is a digital-wallet payment transaction. The digital-wallet payment transaction is related to the purchase, to a previous-purchase, and alternately to a transfer.

It should also be noted that the steps described in the method of use can be carried out in many different orders according to user preference. The use of “step of” should not be interpreted as “step for”, in the claims herein and is not intended to invoke the provisions of 35 U.S.C. § 112(f). It should also be noted that, under appropriate circumstances, considering such issues as design preference, user preferences, marketing preferences, cost, structural requirements, available materials, technological advances, etc., other methods for use, are taught herein.

The embodiments of the invention described herein are exemplary and numerous modifications, variations and rearrangements can be readily envisioned to achieve substantially equivalent results, all of which are intended to be embraced within the spirit and scope of the invention. Further, the purpose of the foregoing abstract is to enable the U.S. Patent and Trademark Office and the public generally, and especially the scientist, engineers and practitioners in the art who are not familiar with patent or legal terms or phraseology, to determine quickly from a cursory inspection the nature and essence of the technical disclosure of the application.

What is claimed is new and desired to be protected by Letters Patent is set forth in the appended claims:

1. A method of use for a justwallet payment system for processing payment transactions comprising the steps of:
providing an authorization algorithm of code which is that of an issuer payment system;
receiving a JUSTWALLET payment;
receiving a payment authorization request message associated with a purchase from a payment network server, and
generating an authorization response message indicative of an outcome of an associated payment authorization request for communication to a corresponding merchant's terminal bridging all payment methods and currencies into 1 platform.

2. The method of use for a justwallet payment system of claim 1, wherein an issuer system has a response-generation IPN configured to identify supplementary data.

3. The method of use for a justwallet payment system of claim 2, wherein said supplementary data has been pre-registered by a justwallet holder.

4. The method of use for a justwallet payment system of claim 3, wherein said supplementary data has been pre-registered by said justwallet holder at an issuer system.

5. The method of use for a justwallet payment system of claim 4, wherein the supplementary data in the authorization response message is configured such that the merchant's terminal is able to extract the supplementary data.

6. The method of use for a justwallet payment system of claim 4, wherein the supplementary data in the authorization response message is configured such that a wallet is able to extract the supplementary data. The method of use for a justwallet payment system of claim 5, wherein the merchant's terminal is able to extract payment for a purchase.

8. The method of use for a justwallet payment system of claim 6, wherein the wallet is able to extract payment for a purchase.

9. The method of use for a justwallet payment system of claim 7, wherein extracted said supplementary data as able to initiate another transaction from the merchant's terminal.

10. The method of use for a justwallet payment system of claim 8, wherein extracted said supplementary data as able to initiate another transaction from the wallet.

11. The method of use for a justwallet payment system of claim 9, wherein the extracted supplementary data is a loyalty transaction.

12. The method of use for a justwallet payment system of claim 10, wherein the extracted supplementary data is a digital-wallet payment transaction.

13. The method of use for a justwallet payment system of claim 11, wherein the loyalty transaction is related to the purchase.

14. The method of use for a justwallet payment system of claim 12, wherein the digital-wallet payment transaction is related to the purchase.

15. The method of use for a justwallet payment system of claim 11, wherein the loyalty transaction is related to another-purchase.

16. The method of use for a justwallet payment system of claim 12, wherein the digital-wallet payment transaction is related to a previous-purchase.

17. The method of use for a justwallet payment system of claim 11, wherein the loyalty transaction is related to a transfer.

18. The method of use for a justwallet payment system of claim 12, wherein the digital-wallet payment transaction is related to a transfer.

19. A method of use for a justwallet payment system for processing payment transactions comprising the steps of:
providing an authorization algorithm of code which is that of an issuer payment system;
receiving a JUSTWALLET payment;
receiving a payment authorization request message associated with a purchase from a payment network server, and
generating an authorization response message indicative of an outcome of an associated payment authorization request for communication to a corresponding merchant's terminal bridging all payment methods and currencies into 1 platform;
wherein an issuer system has a response-generation IPN configured to identify supplementary data;
wherein said supplementary data has been pre-registered by a justwallet holder;
wherein said supplementary data has been pre-registered by said justwallet holder at an issuer system;
wherein the supplementary data in the authorization response message is configured such that the merchant's terminal is able to extract the supplementary data
wherein the merchant's terminal is able to extract payment for purchase;
wherein the extracted supplementary data as able to initiate another transaction from the merchant's terminal; and
wherein the extracted supplementary data is a loyalty transaction related to the purchase and alternately another-purchase and alternately a transfer.

20. A method of use for a justwallet payment system for processing payment transactions comprising the steps of:
providing an authorization algorithm of code which is that of an issuer payment system;
receiving a JUSTWALLET payment;
receiving a payment authorization request message associated with a purchase from a payment network server, and
generating an authorization response message indicative of an outcome of an associated payment authorization request for communication to a corresponding merchant's terminal bridging all payment methods and currencies into 1 platform;
wherein an issuer system has a response-generation IPN configured to identify supplementary data;
wherein said supplementary data has been pre-registered by a justwallet holder;
wherein said supplementary data has been pre-registered by said justwallet holder at an issuer system;
wherein the supplementary data in the authorization response message is configured such that a wallet is able to extract the supplementary data;
wherein the wallet is able to extract payment for a purchase;
wherein the extracted supplementary data as able to initiate another transaction from the wallet;
wherein the supplementary extracted data is a digital-wallet payment transaction; and
wherein the digital-wallet payment transaction is related to the purchase, to a previous-purchase, and alternately to a transfer.
